(19) United States
(12) Patent Application Publication
(10) Pub. No.: US 2025/0188630 A1
(43) Pub. Date: Jun. 12, 2025

(54) OXYNITRIDE CATALYST AND HYDROGEN EVOLUTION DEVICE

(71) Applicant: INDUSTRIAL TECHNOLOGY RESEARCH INSTITUTE, Hsinchu (TW)

(72) Inventors: Li-Duan TSAI, Hsinchu City (TW); Shih-Chang CHEN, Taichung City (TW); Wen-Hsuan CHAO, Zhunan Township (TW)

(73) Assignee: INDUSTRIAL TECHNOLOGY RESEARCH INSTITUTE, Hsinchu (TW)

(21) Appl. No.: 18/773,338

(22) Filed: Jul. 15, 2024

(30) Foreign Application Priority Data
Dec. 6, 2023 (TW) 112147389

(51) Int. Cl. C25B 11/077; C25B 1/04; C25B 11/031; C25B 11/061

(52) U.S. Cl. CPC C25B 11/077; C25B 1/04; C25B 11/031; C25B 11/061

(57) ABSTRACT

An oxynitride catalyst includes NiₐM_{b}N_{c}O_{d}, wherein M is Nb, Mn, or Co, a>0, b>0, c>0, d>0, and a+b+c+d=1. A hydrogen evolution device includes an anode and a cathode dipped in an electrolyte, and the anode includes the oxynitride catalyst. The oxynitride catalyst can be disposed on a support. The oxynitride catalyst may have a polyhedral structure.

### CROSS REFERENCE TO RELATED APPLICATIONS

The present application is based on, and claims priority from, Taiwan Application Serial Number 112147389, filed on Dec. 6, 2023, the disclosure of which is hereby incorporated by reference herein in its entirety.

### TECHNICAL FIELD

The technical field relates to an oxynitride catalyst material, and a hydrogen evolution device having an anode of the oxynitride catalyst material.

### BACKGROUND

Seeking alternative sources of energy is imperative now due to energy shortages, and hydrogen energy is among the best choices. Using hydrogen gas as fuel meets the requirement of environmental sustainability, and electrolysis of water is the easiest way to generate hydrogen and oxygen. Although electrolyzing water to generate hydrogen has many advantages, it still has the fatal flaw of consuming a lot of energy, resulting in an excessive cost. The excessive energy consumption is related to an excessive onset potential, and the onset potential is related to electrodes, electrolytes, and the products of the electrochemical reaction. In seeking to enhance the efficiency of electrolyzing water, the electrode is critical to lowering the activation energy and increasing the reaction interface. The activation energy can be decreased by the catalysis of the electrode surface, which is determined by the inherent catalytic properties of the electrode material.

In the process of the alkaline water electrolysis, the reactions at the cathode and the anode are shown below:

The reaction formula at the cathode:

2H₂O+2e⁻→H₂+2OH⁻(Hydrogen evolution reaction,HER)

The reaction formula at the anode:

2OH⁻→H₂O+½O₂+2e⁻(Oxygen evolution reaction,OER)

The reaction at the anode is the rate-determining step. Although a noble metal such as Pt or IrO₂ is the most efficient catalytic electrode material, it is very expensive. IrO₂ should be replaced with another material to lower the cost.

Accordingly, a novel non-noble metal catalyst composition with low onset potential and high current activity is called for to increase activity of the anode for electrolysis to generate hydrogen. In addition, the novel catalyst composition should simultaneously achieve the catalyst activity and lower the cost.

### SUMMARY

One embodiment of the disclosure provides an oxynitride catalyst, including: NiₐM_{b}N_{c}O_{d}, wherein M is Nb, Mn, or Co, wherein a>0, b>0, c>0, d>0, and a+b+c+d=1.

In some embodiments, M is Nb, 0.365≤a≤0.502, 0.007≤b≤0.107, 0.290≤c≤0.383, and 0.144≤d≤0.239.

In some embodiments, M is Mn, 0.183≤a≤0.447, 0.027≤b≤0.270, 0.353≤c≤0.393, and 0.147≤d≤0.194.

In some embodiments, M is Co, 0.407≤a≤0.475, 0.005≤b≤0.109, 0.382≤c≤0.425, and 0.057≤d≤0.135.

In some embodiments, the oxynitride catalyst has a polyhedral structure.

In some embodiments, the polyhedral structure has a side length of 5 nm to 150 nm and a height of 5 nm to 150 nm.

One embodiment of the disclosure provides a hydrogen evolution device, including: an anode and a cathode dipped in an electrolyte, wherein the anode includes the described oxynitride catalyst.

In some embodiments, the electrolyte includes an alkaline or neutral aqueous solution.

In some embodiments, the electrolyte includes an aqueous solution of potassium hydroxide or sodium carbonate.

In some embodiments, the oxynitride catalyst is disposed on a support.

In some embodiments, the support includes carbon material, metal, conductive oxide, conductive nitride, or a combination thereof.

In some embodiments, the support is sheet-shaped, mesh-shaped, foam-shaped, or porous.

In some embodiments, the support includes stainless steel mesh, iron mesh, nickel mesh, copper mesh, or titanium mesh.

In some embodiments, the oxynitride catalyst is in the form of a layer.

A detailed description is given in the following embodiments with reference to the accompanying drawings.

### BRIEF DESCRIPTION OF THE DRAWINGS

The disclosure can be more fully understood by reading the subsequent detailed description and examples with references made to the accompanying drawings, wherein:

FIGS. 1A to 1C show SEM photographs of catalyst morphology in some embodiments of the disclosure.

FIGS. 2A to 2C show SEM photographs of catalyst morphology in some embodiments of the disclosure.

FIGS. 3A to 3C show SEM photographs of catalyst morphology in some embodiments of the disclosure.

FIGS. 4A to 4D show SEM photographs of catalyst morphology in some embodiments of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

One embodiment of the disclosure provides an oxynitride catalyst, including: NiₐM_{b}N_{c}O_{d}, wherein M is Nb, Mn, or Co, wherein a>0, b>0, c>0, d>0, and a+b+c+d=1. In some embodiments, M is Nb, 0.365≤a≤0.502, 0.007≤b≤0.107, 0.290≤c≤0.383, and 0.144≤d≤0.239. In some embodiments, M is Mn, 0.183≤a≤0.447, 0.027≤b≤0.270, 0.353≤c≤0.393, and 0.147≤d≤0.194. In some embodiments, M is Co, 0.407≤a≤0.475, 0.005≤b≤0.109, 0.382≤c≤0.425, and 0.057≤d≤0.135. If M is another element such as Pd, NiₐM_{b}N_{c}O_{d} will have no effect or poor effect when used as an anode catalyst. If a or b is too large or too small, the anode catalyst utilizing the oxynitride for electrolyzing water to generate hydrogen and oxygen will have an excessive onset potential or an overly low OER activity. If c or d is too large, the anode catalyst utilizing the oxynitride for electrolyzing water to generate hydrogen and oxygen will have an excessive onset potential or an overly low OER activity. If c or d is too small, the content of nitrogen or oxygen will be too low, such that the oxynitride catalyst tends to be in an alloy state. As such, a Ni(OH)₂ layer (which may easily dissociate water) formed on the oxynitride catalyst serving as the anode catalyst is relatively little when water is electrolyzed to generate hydrogen and oxygen, and the onset potential will be higher or the OER activity will be lower. Note that the element ratios of the oxynitride catalyst materials are analyzed by energy-dispersive X-ray spectroscopy (EDS). The operation steps of EDS are shown below. 1. The operating voltage of SEM is 15 kV (can be 20 kV if necessary), the working distance (WD) is 8.5 mm, and the EDS measuring live time is 60 to 120 seconds. 2. Before analyzing the test sample, a copper-containing sample is used to collect spectrum and correct peak (Cu—Ka correction). 3. Perform the qualitative analysis operations to acquire x-ray signal spectrum, and define the more accurate qualitative analysis results from the measured elements. 4. Perform the semi-quantitative analysis based on the elements measurement from the qualitative analysis results.

In some embodiments, the oxynitride catalyst has a polyhedral structure. In some embodiments, the polyhedral structure has a side length of 5 nm to 150 nm and a height of 5 nm to 150 nm. The side length and the height of the polyhedral structure are related to the M content (b). If the M content (b) is too much or too little, the polyhedral structure will have a side length/height that is too small or too large. As a result, the anode catalyst utilizing the oxynitride for electrolyzing water to generate hydrogen and oxygen will have an excessive onset potential or an overly low OER activity.

One embodiment of the disclosure provides a hydrogen evolution device, including: an anode and a cathode dipped in an electrolyte. A potential can be applied to the anode and the cathode of the hydrogen evolution device to electrolyze water, such that the cathode generates hydrogen and the anode generates oxygen. The anode includes the described oxynitride catalyst. In some embodiments, the oxynitride catalyst can be in the form of a layer. In some embodiments, the electrolyte includes an alkaline or neutral aqueous solution. In some embodiments, the electrolyte includes an aqueous solution of potassium hydroxide or sodium carbonate. If the electrolyte is acidic, it will not conduct the hydroxide ions between the anode and cathode, and it may deactivate the device. In some embodiments, the alkaline aqueous solution has a pH value of 10 to 15. If the pH value of the alkaline aqueous solution is too high, the viscosity of the solution will be too high.

It should be understood that the oxynitride catalyst can be used in an anode of several electrolysis devices for hydrogen evolution, such as an anode of membrane electrode assembly, conventional electrolytic cell, or alkaline electrolyte electrolytic cell (containing structural characters such as liquid electrolyte and porous separator). Accordingly, the oxynitride catalyst in some embodiments of the disclosure may satisfy the requirement of electrolyzing alkaline aqueous solution to generate hydrogen. In addition, the oxynitride catalyst has a high conductive ability and high electrochemical activity of OER.

In some embodiments, the oxynitride catalyst layer having a thickness of about 50 nm to 1200 nm can be formed on the support to serve as an anode. If the thickness of the oxynitride catalyst layer is too thin, the loading amount of the catalyst will be insufficient and the OER activity will be too low. If the thickness of the oxynitride catalyst layer is too thick, the stress of the oxynitride catalyst layer coated on the support will be too high. As such, the adhesion between the catalyst layer and the support is not good enough. As the reaction continues, the oxynitride catalyst will be gradually dissolved and peeled off from the electrode, such that the catalyst activity will decay more quickly.

In some embodiments, the oxynitride catalyst is disposed on a support. In some embodiments, the support includes carbon material, metal, conductive oxide, conductive nitride, or a combination thereof.

For example, the metal can be titanium, titanium alloy, nickel, nickel alloy, aluminum, aluminum alloy, stainless steel, another suitable metal, alloy thereof, or a combination thereof. In some embodiments, the support includes stainless steel mesh, iron mesh, nickel mesh, copper mesh, or titanium mesh. For example, the carbon material can be glassy carbon, carbon black, graphite, carbon nanotube, carbon fiber, carbon microbead, another suitable carbon material, or a combination thereof. In some embodiments, the support may be sheet-shaped, mesh-shaped, foam-shaped, porous, or a combination thereof.

Below, exemplary embodiments are described in detail with reference to accompanying drawings so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

### EXAMPLES

### Example 1

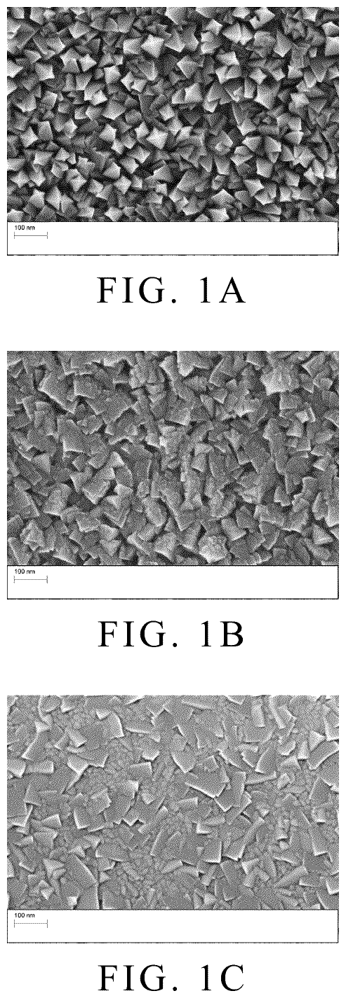

NiₐNb_{b}N_{c}O_{d} catalyst materials of different element ratios were respectively deposited on glassy carbon electrodes (5 mm OD×4 mm H) by the reactive magnetron sputtering. A Ni target and an Nb target were placed in sputtering equipment, the sputtering power applied to the Ni target was adjusted to 10 W to 200 W, the sputtering power applied to the Nb target was adjusted to 50 W to 200 W, a mixture gas (having a total flow rate of 20 sccm) of nitrogen (having a flow rate of 1 seem to 20 sccm), oxygen (having a flow rate of 0.01 seem to 1 sccm), and argon (having a flow rate of 1 seem to 20 sccm) was introduced to the chamber of the sputtering equipment, and the pressure in the chamber of the sputtering equipment was 20 mTorr. The Ni target and the Nb target were bombarded by the gas ions to perform the reactive sputtering at room temperature for 7 minutes to 8 minutes, thereby forming NiₐNb_{b}N_{c}O_{d} catalyst film with a thickness of about 100 nm on the glassy carbon electrode. The compositions of the NiₐNb_{b}N_{c}O_{d} catalyst materials were analyzed by energy-dispersive X-ray spectroscopy (EDS), as tabulated in Table 1. The NiₐNb_{b}N_{c}O_{d} catalyst materials were analyzed by SEM, which showed a polyhedral structure morphology. The polyhedral structure had a side length of 5 nm to 150 nm and a height of 5 nm to 150 nm. The OER electrochemical activities of the NiₐNb_{b}N_{c}O_{d} catalyst materials of different composition ratios were tested. In 0.1 M of KOH solution, Hg/HgO was served as a reference electrode to perform LSV measurement of the oxygen evolution reaction (OER) instrument. During the LSV measurement, the electrode was rotated at 1600 rpm, the scan voltage ranged from 0.32 V to 1 V, the scan rate was 10 mV/s, and the number of scans was 3. The electrochemical properties of the NiₐNb_{b}N_{c}O_{d} films were shown in Table 1, in which Nb/(Ni+Nb+N+O) was 0.007 to 0.107 to achieve better OER activities. The best OER activity (e.g. the current density (mA/cm²) corresponding to the reversible hydrogen electrode (RHE) potential of 1.878 V) was 36.4 J (mA/cm²), and its onset potential was 1.545 V. The morphology of Serial No. 1-12 catalyst is shown as the SEM photograph in FIG. 1A, the morphology of Serial No. 1-8 catalyst is shown as the SEM photograph in FIG. 1B, and the morphology of Serial No. 1-3 catalyst is shown as the SEM photograph in FIG. 1C. As shown in the SEM photographs, the catalyst has a morphology of polyhedral structure.

TABLE 1

| Serial | | Onset potential | OER activity |
|---|---|---|---|
| No. | Composition | (V) | (J, mA/cm²) |
| 1-1 | Ni_{0.243}Nb_{0.246}N_{0.235}O_{0.276} | 1.583 | 22.83 |
| 1-2 | Ni_{0.304}Nb_{0.175}N_{0.265}O_{0.256} | 1.554 | 27.44 |
| 1-3 | Ni_{0.363}Nb_{0.110}N_{0.288}O_{0.239} | 1.553 | 32.27 |
| 1-4 | Ni_{0.365}Nb_{0.107}N_{0.290}O_{0.238} | 1.553 | 33.45 |
| 1-5 | Ni_{0.388}Nb_{0.077}N_{0.319}O_{0.216} | 1.547 | 33.58 |
| 1-6 | Ni_{0.415}Nb_{0.048}N_{0.338}O_{0.199} | 1.544 | 33.65 |
| 1-7 | Ni_{0.416}Nb_{0.045}N_{0.34}O_{0.199} | 1.544 | 33.74 |
| 1-8 | Ni_{0.428}Nb_{0.027}N_{0.373}O_{0.172} | 1.545 | 36.40 |
| 1-9 | Ni_{0.430}Nb_{0.024}N_{0.375}O_{0.171} | 1.545 | 36.33 |
| 1-10 | Ni_{0.429}Nb_{0.015}N_{0.380}O_{0.176} | 1.544 | 35.82 |
| 1-11 | Ni_{0.439}Nb_{0.009}N_{0.383}O_{0.169} | 1.544 | 35.23 |
| 1-12 | Ni_{0.502}Nb_{0.007}N_{0.347}O_{0.144} | 1.540 | 35.32 |
| 1-13 | Ni_{0.507}N_{0.350}O_{0.143} | 1.552 | 33.10 |

### Example 2

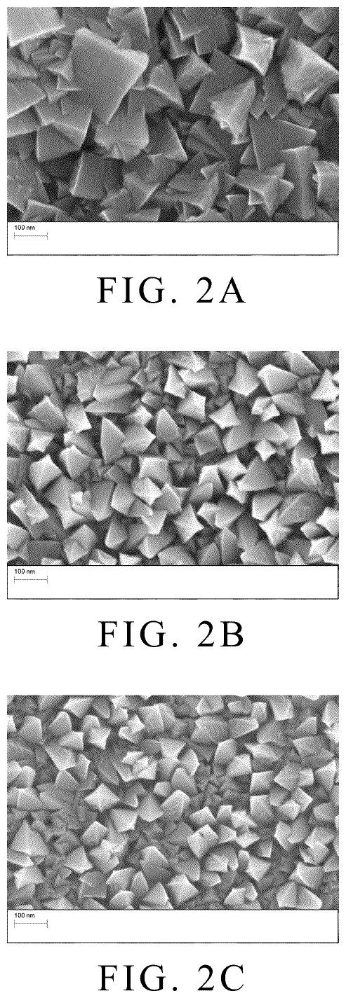

NiₐMn_{b}N_{c}O_{d} catalyst materials of different element ratios were respectively deposited on glassy carbon electrodes (5 mm OD×4 mm H) by the reactive magnetron sputtering. A Ni target and an Mn target were placed in sputtering equipment, the sputtering power applied to the Ni target was adjusted to 10 W to 200 W, the sputtering power applied to the Mn target was adjusted to 10 W to 200 W, a mixture gas (having a total flow rate of 20 sccm) of nitrogen (having a flow rate of 1 seem to 20 sccm), oxygen (having a flow rate of 0.01 seem to 1 sccm), and argon (having a flow rate of 1 seem to 20 sccm) was introduced to the chamber of the sputtering equipment, and the pressure in the chamber of the sputtering equipment was 20 mTorr. The Ni target and the Mn target were bombarded by the gas ions to perform the reactive sputtering at room temperature for 7 minutes to 8 minutes, thereby forming NiₐMn_{b}N_{c}O_{d} catalyst film with a thickness of about 100 nm on the glassy carbon electrode. The compositions of the NiₐMn_{b}N_{c}O_{d} catalyst materials were analyzed by EDS, as tabulated in Table 2. The NiₐMn_{b}N_{c}O_{d} catalyst materials were analyzed by SEM, which showed a polyhedral structure morphology. The polyhedral structure had a side length of 5 nm to 150 nm and a height of 5 nm to 150 nm. The OER electrochemical activities of the NiₐMn_{b}N_{c}O_{d} catalyst materials of different composition ratios were tested. In 0.1 M of KOH solution, Hg/HgO was served as a reference electrode to perform LSV measurement of the OER instrument. During the LSV measurement, the electrode was rotated at 1600 rpm, the scan voltage ranged from 0.32 V to 1 V, the scan rate was 10 mV/s, and the number of scans was 3. The electrochemical properties of the NiₐMn_{b}N_{c}O_{d} films were shown in Table 2, in which Mn/(Ni+Mn+N+O) was 0.027 to 0.270 to achieve better OER activities. The best OER activity (e.g. the current density (mA/cm²) corresponding to the RHE potential of 1.878 V) was 47.8 J (mA/cm²), and its onset potential was 1.514 V. The morphology of Serial No. 2-8 catalyst is shown as the SEM photograph in FIG. 2A, the morphology of Serial No. 2-5 catalyst is shown as the SEM photograph in FIG. 2B, and the morphology of Serial No. 2-1 catalyst is shown as the SEM photograph in FIG. 2C. As shown in the SEM photographs, the catalyst has a morphology of polyhedral structure.

TABLE 2

| Serial | | Onset potential | OER activity |
|---|---|---|---|
| No. | Composition | (V) | (J, mA/cm²) |
| 2-1 | Ni_{0.183}Mn_{0.270}N_{0.393}O_{0.154} | 1.537 | 36.5 |
| 2-2 | Ni_{0.256}Mn_{0.190}N_{0.397}O_{0.157} | 1.516 | 40.7 |
| 2-3 | Ni_{0.301}Mn_{0.126}N_{0.379}O_{0.194} | 1.514 | 42.2 |
| 2-4 | Ni_{0.406}Mn_{0.092}N_{0.355}O_{0.147} | 1.512 | 40.6 |
| 2-5 | Ni_{0.427}Mn_{0.062}N_{0.353}O_{0.158} | 1.509 | 43.5 |
| 2-6 | Ni_{0.426}Mn_{0.046}N_{0.355}O_{0.173} | 1.516 | 43.2 |
| 2-7 | Ni_{0.422}Mn_{0.028}N_{0.358}O_{0.192} | 1.514 | 47.8 |
| 2-8 | Ni_{0.447}Mn_{0.027}N_{0.363}O_{0.163} | 1.513 | 35.4 |
| 2-9 | Ni_{0.451}Mn_{0.013}N_{0.37}O_{0.166} | 1.519 | 19.0 |
| 2-10 | Ni_{0.507}O_{0.143}N_{0.350} | 1.552 | 33.1 |

### Example 3

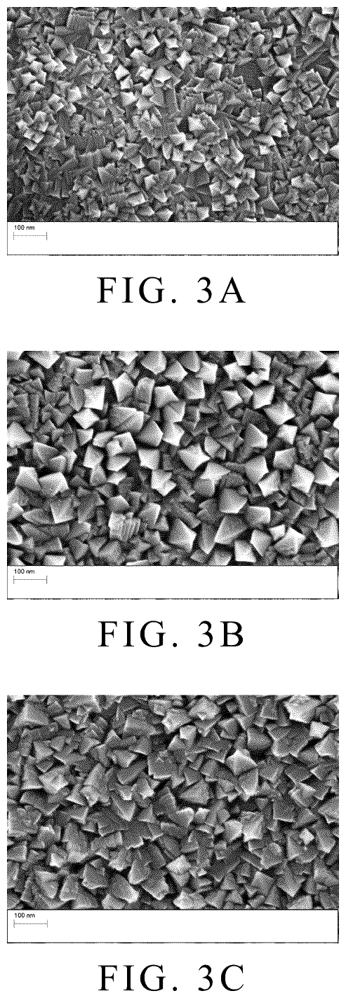

NiₐCo_{b}N_{c}O_{d} catalyst materials of different element ratios were respectively deposited on glassy carbon electrodes (5 mm OD×4 mm H) by the reactive magnetron sputtering. A Ni target and a Co target were placed in sputtering equipment, the sputtering power applied to the Ni target was adjusted to 10 W to 200 W, the sputtering power applied to the Co target was adjusted to 10 W to 200 W, a mixture gas (having a total flow rate of 20 sccm) of nitrogen (having a flow rate of 1 seem to 20 sccm), oxygen (having a flow rate of 0.01 seem to 1 sccm), and argon (having a flow rate of 1 seem to 20 sccm) was introduced to the chamber of the sputtering equipment, and the pressure in the chamber of the sputtering equipment was 20 mTorr. The Ni target and the Co target were bombarded by the gas ions to perform the reactive sputtering at room temperature for 7 minutes to 8 minutes, thereby forming NiₐCo_{b}N_{c}O_{d} catalyst film with a thickness of about 100 nm on the glassy carbon electrode. The compositions of the NiₐCo_{b}N_{c}O_{d} catalyst materials were analyzed by EDS, as tabulated in Table 3. The NiₐCo_{b}N_{c}O_{d} catalyst materials were analyzed by SEM, which showed a morphology of polyhedral structure. The polyhedral structure had a side length of 5 nm to 150 nm and a height of 5 nm to 150 nm. The OER electrochemical activities of the NiₐCo_{b}N_{c}O_{d} catalyst materials of different composition ratios were tested. In 0.1 M of KOH solution, Hg/HgO was served as a reference electrode to perform LSV measurement of the OER instrument. During the LSV measurement, the electrode was rotated at 1600 rpm, the scan voltage ranged from 0.32 V to 1 V, the scan rate was 10 mV/s, and the number of scans was 3. The electrochemical properties of the NiₐCo_{b}N_{c}O_{d} films were shown in Table 3, in which Co/(Ni+Co+N+O) was 0.005 to 0.109 to achieve better OER activities. The best OER activity (e.g. the current density (mA/cm²) corresponding to the RHE potential of 1.878 V) was 45.4 J (mA/cm²), and its onset potential was 1.478 V. The morphology of Serial No. 3-8 catalyst is shown as the SEM photograph in FIG. 3A, the morphology of Serial No. 3-6 catalyst is shown as the SEM photograph in FIG. 3B, and the morphology of Serial No. 3-3 catalyst is shown as the SEM photograph in FIG. 3C. As shown in the SEM photographs, the catalyst has a morphology of polyhedral structure.

TABLE 3

| Serial | | Onset potential | OER activity |
|---|---|---|---|
| No. | Composition | (V) | (J, mA/cm²) |
| 3-1 | Ni_{0.229}Co_{0.239}N_{0.442}O_{0.090} | 1.546 | 28.8 |
| 3-2 | Ni_{0.326}Co_{0.159}N_{0.439}O_{0.076} | 1.537 | 29.5 |
| 3-3 | Ni_{0.409}Co_{0.109}N_{0.425}O_{0.057} | 1.508 | 42.8 |
| 3-4 | Ni_{0.407}Co_{0.059}N_{0.412}O_{0.122} | 1.508 | 42.8 |
| 3-5 | Ni_{0.464}Co_{0.030}N_{0.384}O_{0.122} | 1.509 | 44.4 |
| 3-6 | Ni_{0.456}Co_{0.015}N_{0.403}O_{0.126} | 1.478 | 45.4 |
| 3-7 | Ni_{0.475}Co_{0.008}N_{0.382}O_{0.135} | 1.517 | 43.5 |
| 3-8 | Ni_{0.463}Co_{0.005}N_{0.400}O_{0.132} | 1.517 | 42.8 |
| 3-9 | Ni_{0.507}N_{0.350}O_{0.143} | 1.552 | 33.1 |

### Example 4

The experiment conditions in Serial No. 3-6 of Example 3 were repeated to deposit a Ni_{0.456}Co_{0.015}N_{0.403}O_{0.126} catalyst film having a thickness of about 600 nm on a stainless steel mesh (10 mm×10 mm), a titanium mesh (10 mm×10 mm), and a carbon paper (10 mm×10 mm) respectively. The OER electrochemical activities of Ni_{0.456}Co_{0.015}N_{0.403}O_{0.126} catalyst materials were tested. In 2 M of KOH solution, Hg/HgO was served as a reference electrode to perform LSV measurement of the OER instrument. During the LSV measurement, the electrode was rotated at 1600 rpm, the scan voltage ranged from 0.25 V to 0.97 V, the scan rate was 10 mV/s, and the number of scans was 3. The electrochemical properties of the Ni_{0.456}Co_{0.015}N_{0.403}O_{0.126} films were shown in Table 3. When Co/(Ni+Co+N+O) was 0.015, the OER activity (e.g. the current density (mA/cm²) corresponding to the RHE potential of 1.7 V) of the catalyst on the stainless steel mesh was 197 J (mA/cm²), the OER activity (e.g. the current density (mA/cm²) corresponding to the RHE potential of 1.7 V) of the catalyst on the titanium mesh was 55.4 J (mA/cm²), and the OER activity (e.g. the current density (mA/cm²) corresponding to the RHE potential of 1.7 V) of the catalyst on the carbon paper was 15.2 J (mA/cm²). Accordingly, suitable support such as stainless steel mesh, titanium mesh, and the like could further improve the OER activity of the catalyst.

### Example 5

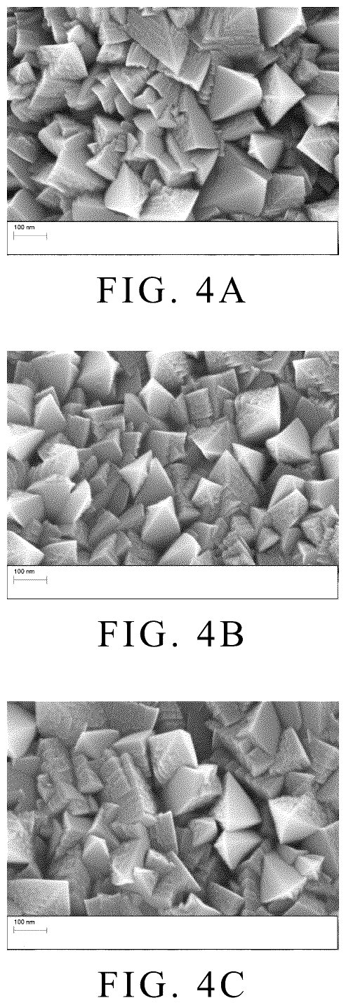

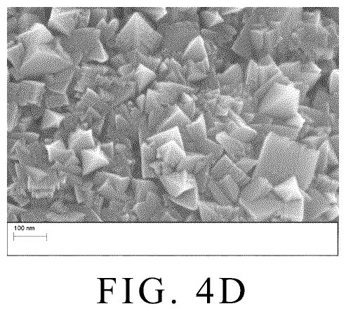

The experiment conditions in Serial No. 3-8, 3-6, 3-5, and 3-3 of Example 3 were repeated to deposit Ni_{0.463}Co_{0.005}N_{0.400}O_{0.132} catalyst, Ni_{0.456}Co_{0.015}N_{0.403}O_{0.126} catalyst, Ni_{0.464}Co_{0.030}N_{0.384}O_{0.122} catalyst, and Ni_{0.409}Co_{0.109}N_{0.425}O_{0.05} catalyst films having a thickness of about 600 nm on stainless steel meshes (10 mm×10 mm), respectively. The catalyst morphology corresponding to Serial No. 3-8 was shown as the SEM photograph in FIG. 4A, the catalyst morphology corresponding to Serial No. 3-6 was shown as the SEM photograph in FIG. 4B, the catalyst morphology corresponding to Serial No. 3-5 was shown as the SEM photograph in FIG. 4C, and the catalyst morphology corresponding to Serial No. 3-3 was shown as the SEM photograph in FIG. 4D. As shown in the SEM photographs, the catalyst has a morphology of polyhedral structure.

### Comparative Example 1

NiₐPd_{b}N_{c}O_{d} catalyst materials of different element ratios were respectively deposited on glassy carbon electrodes (5 mm OD×4 mm H) by the reactive magnetron sputtering. A Ni target and a Pd target were placed in sputtering equipment, the sputtering power applied to the Ni target was adjusted to 10 W to 200 W, the sputtering power applied to the Pd target was adjusted to 10 W to 200 W, a mixture gas (having a total flow rate of 20 sccm) of nitrogen (having a flow rate of 1 seem to 20 sccm), oxygen (having a flow rate of 0.01 seem to 1 sccm), and argon (having a flow rate of 1 seem to 20 sccm) was introduced to the chamber of the sputtering equipment, and the pressure in the chamber of the sputtering equipment was 20 mTorr. The Ni target and the Pd target were bombarded by the gas ions to perform the reactive sputtering at room temperature for 7 minutes to 8 minutes, thereby forming NiₐPd_{b}N_{c}O_{d} catalyst film with a thickness of about 100 nm on the glassy carbon electrode. The compositions of the NiₐPd_{b}N_{c}O_{d} catalyst materials were analyzed by EDS, as tabulated in Table 4. The OER electrochemical activities of the NiₐPd_{b}N_{c}O_{d} catalyst materials of different composition ratios were tested. In 0.1 M of KOH solution, Hg/HgO was served as a reference electrode to perform LSV measurement of the OER instrument. During the LSV measurement, the electrode was rotated at 1600 rpm, the scan voltage ranged from 0.32 V to 1 V, the scan rate was 10 mV/s, and the number of scans was 3. The electrochemical properties of the NiₐPd_{b}N_{c}O_{d} films were shown in Table 4, which shows that all the NiₐPd_{b}N_{c}O_{d} films had low OER activities.

TABLE 4

| Serial | | Onset potential | OER activity |
|---|---|---|---|
| No. | Composition | (V) | (J, mA/cm²) |
| 4-1 | Ni_{0.265}Pd_{0.408}N_{0.273}O_{0.054} | 1.566 | 17.4 |
| 4-2 | Ni_{0.147}Pd_{0.540}N_{0.261}O_{0.052} | 1.561 | 18.9 |
| 4-3 | Ni_{0.128}Pd_{0.571}N_{0.264}O_{0.037} | 1.586 | 17.8 |
| 4-4 | Ni_{0.095}Pd_{0.611}N_{0.260}O_{0.034} | 1.568 | 22.4 |
| 4-5 | Ni_{0.059}Pd_{0.656}N_{0.254}O_{0.031} | 1.561 | 18.4 |
| 4-6 | Ni_{0.040}Pd_{0.681}N_{0.251}O_{0.028} | 1.557 | 21.2 |
| 4-7 | Ni_{0.025}Pd_{0.711}N_{0.238}O_{0.026} | 1.572 | 20.7 |
| 4-8 | Ni_{0.015}Pd_{0.734}N_{0.227}O_{0.024} | 1.579 | 19.6 |

### Comparative Example 2

Pt and Ni catalyst material were respectively deposited on glassy carbon electrodes (5 mm OD×4 mm H) by the reactive magnetron sputter. A Pt target or a Ni target was adopted and argon was introduced to perform the reactive sputtering, thereby depositing the Pt catalyst material or the Ni catalyst material. The argon had a flow rate of 20 seem, the sputtering pressure was controlled to 20 mTorr, the process temperature was controlled to room temperature, the sputtering period was 5 minutes to 6 minutes, and the sputtered film had a thickness of about 100 nm. The OER electrochemical activities of the Pt catalyst material, the Ni catalyst material, and IrOx catalyst material (commercially available from TKK) were tested, respectively. In 0.1 M of KOH solution, Hg/HgO was served as a reference electrode to perform LSV measurement of the OER instrument. During the LSV measurement, the electrode was rotated at 1600 rpm, the scan voltage ranged from 0.32 V to 1 V, the scan rate was 10 mV/s, and the number of scans was 3. The electrochemical properties of the Pt film, the Ni film, and IrOx were shown in Table 5. As known from Table 5, the OER activities of the catalyst materials in Examples were higher than the OER activities of the Pt film, the Ni film, and IrOx.

TABLE 5

| | Onset potential | OER activity |
|---|---|---|
| Composition | (V) | (J, mA/cm²) |
| Pt film | 1.502 | 23.2 |
| Ni film | 1.566 | 30.60 |
| IrOx | 1.489 | 20.05 |

It will be apparent to those skilled in the art that various modifications and variations can be made to the disclosed methods and materials. It is intended that the specification and examples be considered as exemplary only, with the true scope of the disclosure being indicated by the following claims and their equivalents.

What is claimed is:

1. An oxynitride catalyst, comprising:
NiₐM_{b}N_{c}O_{d}, wherein M is Nb, Mn, or Co,
wherein a>0, b>0, c>0, d>0, and a+b+c+d=1.

2. The oxynitride catalyst as claimed in claim 1,
wherein M is Nb, 0.365≤a≤0.502, 0.007≤b≤0.107, 0.290≤c≤0.383, and 0.144≤d≤0.239.

3. The oxynitride catalyst as claimed in claim 1,
wherein M is Mn, 0.183≤a≤0.447, 0.027≤b≤0.270, 0.353≤c≤0.393, and 0.147≤d≤0.194.

4. The oxynitride catalyst as claimed in claim 1,
wherein M is Co, 0.407≤a≤0.475, 0.005≤b≤0.109, 0.382≤c≤0.425, and 0.057≤d≤0.135.

5. The oxynitride catalyst as claimed in claim 1, wherein the oxynitride catalyst has a polyhedral structure.

6. The oxynitride catalyst as claimed in claim 5, wherein the polyhedral structure has a side length of 5 nm to 150 nm and a height of 5 nm to 150 nm.

7. A hydrogen evolution device, comprising:
an anode and a cathode dipped in an electrolyte,
wherein the anode comprises the oxynitride catalyst as claimed in claim 1.

8. The hydrogen evolution device as claimed in claim 7, wherein the electrolyte comprises an alkaline or neutral aqueous solution.

9. The hydrogen evolution device as claimed in claim 7, wherein the electrolyte comprises an aqueous solution of potassium hydroxide or sodium carbonate.

10. The hydrogen evolution device as claimed in claim 7, wherein the oxynitride catalyst is disposed on a support.

11. The hydrogen evolution device as claimed in claim 10, wherein the support comprises carbon material, metal, conductive oxide, conductive nitride, or a combination thereof.

12. The hydrogen evolution device as claimed in claim 10, wherein the support comprises stainless steel mesh, iron mesh, nickel mesh, copper mesh, or titanium mesh.

13. The hydrogen evolution device as claimed in claim 10, wherein the support is sheet-shaped, mesh-shaped, foam-shaped, or porous.

14. The hydrogen evolution device as claimed in claim 7, wherein the oxynitride catalyst is in the form of a layer.
